(19) United States
(12) Patent Application Publication
(10) Pub. No.: US 2014/0179893 A1
(43) Pub. Date: Jun. 26, 2014

(54) BRANCHED LACTIC ACID POLYMERS WITH HIGH VISCOSITY IN THE MOLTEN STATE AND HIGH SHEAR SENSITIVITY, AND NANOCOMPOSITES THEREOF

(71) Applicants: Giuseppe Di Silvestro, Lentate Sul Seveso (MB) (IT); Cuiming Yuan, Milano (IT); Marco Ortenzi, Milano (IT); Tommaso Lugato, Villasanta (MB) (IT); Luca Basilissi, Cornaredo (MI) (IT)

(72) Inventors: Giuseppe Di Silvestro, Lentate Sul Seveso (MB) (IT); Cuiming Yuan, Milano (IT); Marco Ortenzi, Milano (IT); Tommaso Lugato, Villasanta (MB) (IT); Luca Basilissi, Cornaredo (MI) (IT)

(73) Assignees: FONDAZIONE CARIPLO, Milano (IT); UNIVERSITA' DEGLI STUDIO DI MILANO, Milano (IT)

(21) Appl. No.: 14/131,003

(22) PCT Filed: Jul. 6, 2012
(86) PCT No.: PCT/IB2012/053459

§ 371 Date: Mar. 4, 2014

(30) Foreign Application Priority Data
Jul. 8, 2011 (IT) MI2011A001273

(51) Int. Cl. C08G 63/08

(52) U.S. Cl. CPC C08G 63/08
USPC 528/355; 528/354

(57) ABSTRACT

Disclosed is a polymer obtainable by bulk polymerization of lactide or lactic acid or a lactic acid copolymer obtainable by copolymerization of lactide or lactic acid with glycolide, glycolic acid and/or hydroxyacids in open or closed (cyclic) form in the presence of at least two organic and/or organic/inorganic chain regulators or a functionalized nanoparticle (nanosilica, montmorillonite).

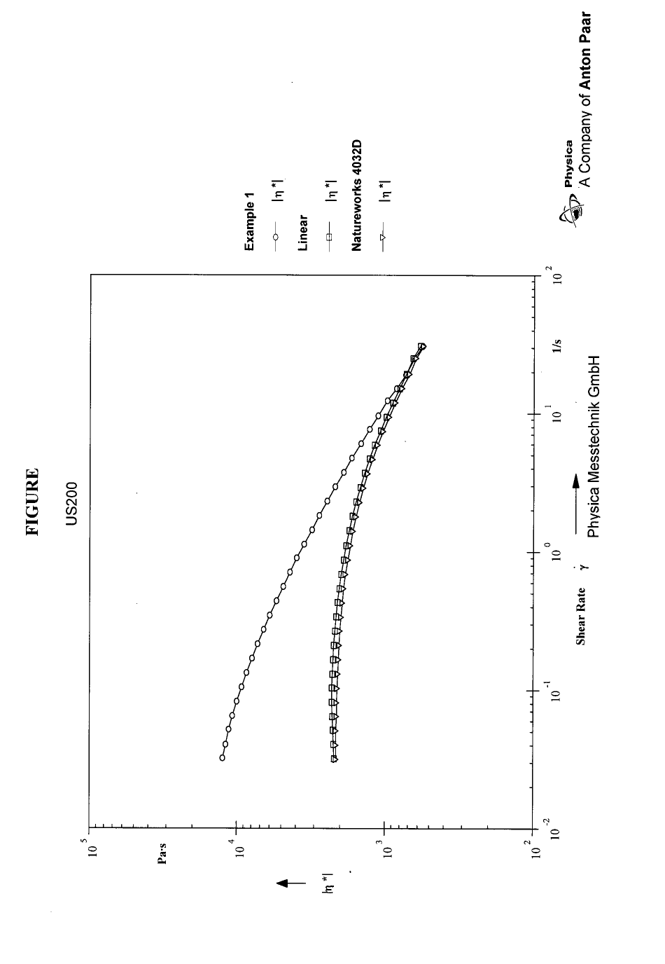

The present invention relates to lactic acid polymers obtainable by polymerization of lactide or lactic acid or lactic acid copolymers obtainable by copolymerization of lactide or lactic acid with glycolide, glycolic acid and/or hydroxyacids in open or closed (cyclic) form in the presence of at least two chain regulators.

### PRIOR ART

Polylactic acid (PLA) is currently used because it is derived from renewable sources and because it is easily broken down in the human body (e.g. suture threads), and for composting purposes. Apart from its biomedical uses, PLA used in packaging, for example, needs to have better rheological properties, higher thermal stability and a more efficient barrier effect. In other applications, even greater resistance to hydrolytic attack is required to increase the life of the articles produced. The PLA most commonly used at industrial level generally derives from L-lactide (PLLA), but the polymer deriving from the D isomer (PDLA) or from the meso isomer or mixtures thereof can also be obtained.

There are few PLA manufacturers at present, and they almost operate as a monopoly; modifications to the material proposed in the literature are mainly performed by mechanical mixing in the molten polymer (compounding), introducing the additives during processing steps after the synthesis of the polymer. This process, performed with extruders, is always inherently less efficient than the same modification performed at the polymerization step due to the very short contact times (a few minutes). The two most important solutions are the use of nanofillers or structural modification of the PLA by chain regulators.

Linear or branched PLAs are described in the literature; branched PLAs described in the literature have dendrimer structure with strictly controlled synthesis and polydispersity of molecular weights close to 1. The use of nanofillers, which may be surface-modified, in both compounding and synthesis in situ, is also described.

The use of nanocomposites obtained by mixing PLA in suitable conditions with graphite, montmorillonite and other silicates is known in particular.

The preparation and properties of these nanocomposites are described, for example, by Kim, Il-Hwan et al., Journal of Polymer Science, Part B: Polymer Physics (2010), 48(8), 850-858; Yu, Tao et al., Transactions of Nonferrous Metals Society of China (2009), 19(Spec. 3), s651-s655; Chen, Nali et al., Advanced Polymer Processing), 422-426; and W. S. Chow et al., Journal of Thermal Analysis and Calorimetry, Vol. 95 (2009) 2, 627-632.

It is also known that 1/1 mechanical mixtures of PLLA/PDLA present higher melting points than PLLA or PDLA because they form a different and more stable crystalline phase; this different crystalline phase is identified as adduct PLLA/PDLA.

### DESCRIPTION OF THE INVENTION

It has now been found that novel PLA-based materials can be obtained not by additivation and/or compounding, but directly in the polymerization step, leading to improved thermal, rheological, mechanical and gas permeability properties.

The lactic acid polymers according to the invention have a branched structure created with different combinations of multifunctional chain regulators of an organic or mixed inorganic-organic nature. The choice of said regulators is based on the nature of the monomer(s) used. The polymers according to the invention can have higher molecular masses than the PLAs currently known, and the viscosities in the molten mass can be over an order of magnitude greater than those of the PLAs now on the market. The polymers according to the invention can also present high shear sensitivity which allows advanced technological applications, while the presence of nanofillers strongly interacting with the polymer matrix contributes to a significant reduction in the permeability of gases through PLA films.

It is also possible to modify the crystallizability and mechanical properties of PLA for applications other than packaging by suitably selecting the structure and properties of the chain regulators, and optionally by adding comonomers. The hydrophilia and moduli of elasticity of PLAs can also be varied.

The polymers according to the invention are also particularly advantageous when used to prepare PLLA/PDLA adducts for which an economically more advantageous ratio than the stoichiometric composition has been identified.

In its more general aspect, the invention provides lactic acid polymers obtainable by polymerization of lactide or lactic acid or lactic acid copolymers obtainable by copolymerization of lactide or lactic acid with glycolide, glycolic acid and/or hydroxyacids in open or closed (cyclic) form in the presence of at least two organic and/or organic/inorganic chain regulators or a functionalized nanoparticle (nanosilica, montmorillonite).

The organic or organic-inorganic chain regulator has at least one functional group able to react with the terminal groups of another chain regulator and/or the monomer. An organic-inorganic chain regulator is a mineral nanoparticle functionalized with organic molecules, as described below.

The chain regulators are preferably selected from:

a) at least two chain regulators, one of which has at least two functional groups able to react with the functional groups of the other regulator and/or the monomer;

b) a silica or a montmorillonite (or other inorganic structures based on other metals) functionalized with silanes and at least one chain regulator, having at least one functional group able to react with the functional groups of the monomer and/or the silica or montmorillonite functionalized with silanes;

c) a silica or montmorillonite (or other inorganic structures based on other metals) functionalized with silanes containing reactive groups which can react with the growing polymer and/or the monomer.

According to a first preferred aspect of the invention, the lactide or lactic acid is polymerized or copolymerized with glycolide, glycolic acid and/or hydroxyacids in the presence of two chain regulators, one of which has at least two functional groups able to react with the functional groups of the other regulator and/or the monomer. Examples of said functional groups include hydroxy, carboxy, amino and isocyanate groups or derivatives thereof such as esters, epoxides, amides and blocked isocyanates.

The regulators are preferably selected from polyols, hydroxyacids, polyacids, polycarboxylic acid anhydrides, polyamines, amino acids, polyisocyanates and polyepoxides. Typically, one of the two regulators is a diol, polyethylene glycol, perfluoropolyether with hydroxy, acid, ester or amido terminal groups or a polyol, and the other is a diacid or polyacid or corresponding anhydrides.

One of the chain regulators is preferably ethylene glycol, 1,4-butanediol, 1,6-hexanediol, 1,8-octanediol, and more generally a diol derived from oligomerisation/polymerization/copolymerization of ethylene oxide, propylene oxide and THF or trimethylolpropane, pentaerythritol, dipentaerythritol, cyclodextrin and polyols derived from sugars in general, 1,4-, 1,2-, 1,3-benzenedimethanol, 1,4-, 1,2- 1,3-cyclohexanedimethanol, perfluoropolyether with hydroxy, acid, ester or amid terminal groups, and the other chain regulator is mellitic anhydride, fumaric anhydride, succinic anhydride, phthalic anhydride, maleic anhydride or 1,2,4,5-benzenetetracarboxylic acid dianhydride (pyromellitic anhydride).

According to another preferred aspect of the invention, the lactide or lactic acid is polymerized or copolymerized with glycolide, glycolic acid and/or hydroxyacids in the presence of a silica or montmorillonite functionalized with silanes and at least one chain regulator, having at least one functional group able to react with the functional groups of the monomer and/or the silica or montmorillonite functionalized with silanes. The functional groups and the chain regulator are identical to those described above.

The silica or montmorillonite is preferably functionalized with one or more silanes according to the generic formula below

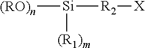

wherein R and R₁═—CH₃, —CH₂CH₃ or i-propyl, n═1-3, m═3-n, R₂═—CH₂—, —(CH₂)₂—, —(CH₂)₃— and X=epoxide, —NH₂, aliphatic chain C1-C15, —NCO, —NH—(CH₂)ₓ—NH₂, aryl groups, optionally mixed with silanes of formula (CH₃)ₓ—Si—(OR)₄₋ₓ, where x is 4 or less, in the amount of up to 50% in moles of the functionalized silane.

Alternatively, (co)polymerization can be performed only with silica or montmorillonite functionalized with silanes, in the absence of a second chain regulator.

Silicas functionalized with silanes are known and available on the market, and contain a maximum of 5% by weight of silanizing agent.

The use of silica or montmorillonite with particles of nanometric dimensions is preferred, in which case the amount by weight of silane can range between 0.01% and 80% by weight of the mineral. The nanoparticles can be introduced in amounts by weight ranging between 0.01% and 20% of the monomer, preferably between 0.2% and 8%, and even more preferably between 0.3% and 5%.

The polymers obtainable according to the invention present a molecular weight interval (Mn, number average molecular weight) from 5000 to 1,000,000 Daltons, preferably from 10,000 to 500,000 Daltons and even more preferably from 30,000 to 400,000 Daltons expressed by SEC (Size Exclusion Chromatography) in linear polystyrene equivalents.

The properties of the PLA polymer can be modulated, depending on the modifying agent used.

For example, the viscosity of the molten mass and the permeability can be improved by using the chain regulators described in paragraph a) above, optionally in combination with montmorillonites. The use of fluorinated chain regulators allows the hydrophobia, measured on the basis of the contact angle, to be increased.

According to the alternative described in paragraph c), for example with the use of silica functionalized with silanes, the crystallizability and permeability of the molten mass can be improved, and its viscosity increased.

The polymers reported in examples 1 to 5 were obtained with the ROP (Ring Opening Polymerization) methodology in the presence of Sn octanoate as catalyst. The choice of catalyst is not selective. The monomer (lactide), the comonomers, if any, and the chain regulators are heated to 180° C. in an inert atmosphere under stirring for 1.5 h. The polymer is cooled to room temperature, still under nitrogen, and then recovered. The equilibrium lactide present is eliminated by treatment at 150° C. under mechanical vacuum (10⁻⁴ Torr) overnight (Solid State Polymerization-SSP). Alternatively, the polymer can be extruded in the molten state from the die at the base of the reactor used, and subsequently treated with SSP. Another alternative is for the recovered polymer to be excluded from the SSP treatment.

As a wide range of combinations of chain regulators can be used, in terms of both structure and stoichiometric ratio, such as combinations of polyol (preferably diol) and polyacid, a very large number of PLAs can be obtained which have conceptually similar structures, but differ in terms of SEC and rheological behaviour, crystallisation kinetics, thermal stability and contact angle with the modified PLA/water interface. The amounts of chain regulators range from 0.01% to 20% by weight of the monomer(s), preferably from 0.02% to 10% by weight, and even more preferably from 0.03% to 7.5% by weight.

Examples 6 and 7 were obtained by polycondensation from lactic acid in the presence of a mixture of catalysts. The lactic acid solution is anhydrified at 130° C. in mechanical vacuum, after which the monomer, the comonomers and the catalysts are heated to 180° C. in an inert atmosphere, under mechanical stirring. The mechanical vacuum is applied gradually. The reaction is carried out for 7 h under vacuum. At the end of polymerization the polymer is treated as described above for PLA synthesized from lactide. The results obtained for PLA can be transferred, on the basis of general knowledge, to other polymers and/or copolymers obtainable from different hydroxyacids.

The invention is described in greater detail in the examples below.

### EXAMPLE 1

50 g LL lactide

0.3% w/w Sn(Oct)₂

0.125% molar 1,6 hexanediol

0.0625% molar 1,2,4,5-benzenetetracarboxyolic dianhydride

Reaction carried out at 180° C. in a 250 mL glass flask, mechanical stirring, and nitrogen flow for 1 h 30 min.

### Modification of Rheological Behaviour (Figure)

Rheological behaviour: the viscosity of the molten mass (at zero shear rate) at 190° C. of an industrial standard PLA (Natureworks 4032D) is 2500 Pa*s, while the viscosity of one of our straight PLAs synthesized in the laboratory is 2200 Pa*s, and that of the sample described in example 1 is 13500 Pa*s. Moreover the sample has high shear sensitivity, because at high deformations it has a viscosity similar to that of the industrial sample and the standard.

### EXAMPLE 2

50 g LL lactide

0.3% w/w Sn(Oct)₂

0.125% molar 1,6 hexanediol

0.0625% molar 1,2,4,5-benzenetetracarboxyolic dianhydride

1% w/w nanosilica

Reaction carried out at 180° C. in a 250 mL glass flask, mechanical stirring, and nitrogen flow for 1 h 30 min.

### Increased Thermal Stability, Modified Rheological Behaviour, Increased Barrier Properties

Thermal Stability: in TGA (Thermogravimetric Analysis), PLA, synthesized in the laboratory without the addition of stabilisers, loses 1% of its weight at 238° C. and 95% at 313° C.

This PLA loses 1% at 313° C. and 95% at 390° C.

Rheological behaviour: the viscosity of the molten mass (with zero shear rate) at 190° C. of an industrial standard PLA is 2500 Pa*s, while the viscosity of our PLA synthesized in the laboratory is 2200 Pa*s, and that of the sample described in example 2 is 5200 Pa*s.

Barrier properties: the third sample in the table below is the polymer described in example 2. The data are obtained on films produced by casting from solution.

| | O₂ TR | H₂O TR | CO₂ TR |
|---|---|---|---|
| | (ccmicrom/m2 | (gmicrom/m2 | (ccmicrom/m2 |
| Sample | 24 h bar) | 24 h bar) | 24 h bar) |
| Commercial PLA | 188.27 | 9.48 | 236.66 |
| Linear PLA - | 114.34 | 3.50 | 208.52 |
| laboratory | | | |
| synthesis | | | |
| 1% silica | 64.16 | 2.06 | 187.46 |

### EXAMPLE 3

50 g LL lactide

0.1% w/w Sn(Oct)₂

1% w/w nanosilica surface-modified with 15% epoxy silane (GENIOSIL GF80).

Reaction carried out at 180° C. in a 250 mL glass flask, mechanical stirring, and nitrogen flow for 1 h 30 min.

### Increased Thermal Stability

Thermal Stability: in TGA (Thermogravimetric Analysis), PLA, synthesized in the laboratory without the addition of stabilisers, loses 1% of its weight at 238° C. and 95% at 313° C.

This PLA loses 1% at 264° C. and 95% at 381° C.

### EXAMPLE 4

50 g LL lactide

0.3% w/w Sn(Oct)₂

0.125% molar 1,6 hexanediol

0.0625% molar 1,2,4,5-benzenetetracarboxyolic dianhydride

1% w/w CLOISITE 15A

Reaction carried out at 180° C. in a 250 mL glass flask, mechanical stirring, and nitrogen flow for 1 h 30 min.

### Increased Barrier Properties

Barrier properties: the third sample in the table below is the polymer described in example 4. The data are obtained on films produced by casting from solution.

| | O₂ TR | H₂O TR | CO₂ TR |
|---|---|---|---|
| | (ccmicrom/m2 | (gmicrom/m2 | (ccmicrom/m2 |
| Sample | 24 h bar) | 24 h bar) | 24 h bar) |
| Commercial | 188.27 | 9.48 | 236.66 |
| PLA | | | |
| Linear PLA | 114.34 | 3.50 | 208.52 |
| 1% CLO 15A | 92.63 | 2.08 | 173.42 |

### EXAMPLE 5

50 g LL lactide

0.1% w/w Sn(Oct)2

0.1% molar FLUOROLINK E10H: FLUOROLINK oligomers are PFPEs (PerFluoroPolyEthers) manufactured by SOLVAY SOLEXIS, and are taken as an example of commercial PFPEs having different terminal groups (for example —COOH, CF₂—OH, CF₂—CH₂—OH, amido groups such as —CF₂—CONH—C₁₈H₃₇ or other aliphatic chains).

0.05% molar 1,2,4,5-benzenetetracarboxyolic dianhydride

Reaction carried out at 180° C. in a 250 mL glass flask, mechanical stirring and nitrogen flow for 1 h 30 min.

### Increased Hydrophobicity

Contact angle: on a standard commercial PLA film obtained by casting, a contact angle of 85° was obtained, whereas the sample described in example 5 gives a contact angle of 125°.

### EXAMPLE 6

### Comparative Example of PLA Produced by Polycondensation

100 g of 85% w/w aqueous solution of lactic acid

Water removed at 130° C. under mechanical vacuum

0.3% w/w SnCl₂

0.3% w/w p-toluenesulphonic acid

0.3% w/w Sb₂O₃

Reaction carried out at 180° C. in a 250 mL glass flask, mechanical stirring and vacuum for 7 h.

Properties: the polymer is comparable with a standard PLA obtained from lactide.

### EXAMPLE 7

### Comparative Example of PLA Produced by Polycondensation

100 g of 85% w/w aqueous solution of lactic acid

Water removed at 130° C. under mechanical vacuum

0.3% w/w SnCl₂

0.3% w/w p-toluenesulphonic acid

0.3% w/w Sb₂O₃

0.125% molar 1,6 hexanediol

0.0625% molar 1,2,4,5-benzenetetracarboxyolic dianhydride

Reaction carried out at 180° C. in a 250 mL glass flask, mechanical stirring and vacuum for 7 h.

Properties: the polymer has a complex architecture due to the multifunctional agents.

1. A homopolymer obtainable by bulk polymerization of lactide monomers or lactic acid or a copolymer obtainable by copolymerization of lactide monomers or lactic acid with glycolide monomers, glycolic acid and/or hydroxyacids in open or closed (cyclic) form, said polymerization or copolymerization being performed in the presence of at least two chain regulators or in the presence of at least one functionalized nanoparticle, optionally in combination with one or more chain regulators, the percentage by weight of the homo- or copolymer being at least 80% in the material obtained during polymerization.

2. A polymer or copolymer as claimed in claim 1 wherein the chain regulators are organic or organic-inorganic hybrids.

3. A polymer or copolymer as claimed in claim 1 wherein the chain regulators are selected from:
a) at least two chain regulators having functional groups, one of which has at least two functional groups capable of reacting with functional groups of the other regulator or the monomer or both;
b) at least one silica or one montmorillonite functionalized with silanes and at least one chain regulator, having at least one functional group capable of reacting with functional groups of the monomer or the silica or the montmorillonite functionalized with silanes, or both; and
c) at least one silica or one montmorillonite functionalized with silanes containing reactive groups which can react with the growing polymer.

4. A polymer or copolymer as claimed in claim 3, wherein the chain regulators and/or the silica or the montmorillonite are present in amounts of between 0.01 and 20% in weight of the monomers.

5. A polymer/copolymer as claimed in claim 1, wherein the monomer(s) is/are polymerized with two chain regulators, having functional groups one of which has at least two functional groups capable of reacting with functional groups of the other regulator and/or the monomer, or both.

6. A polymer/copolymer as claimed in claim 1, wherein the monomer(s) is/are polymerized in the presence of at least one silica or one montmorillonite functionalized with silanes and at least one chain regulator, having at least one functional group capable of reacting with functional groups of the monomer or the silica or the montmorillonite functionalized with silanes, or both.

7. A polymer/copolymer as claimed in claim 1, wherein the monomer(s) is/are polymerized in the presence of at least one silica or one montmorillonite functionalized with silanes containing reactive groups which can react with the growing polymer.

8. A polymer/copolymer as claimed in claim 3 wherein the functional groups of the chain regulator(s) are hydroxy, carboxy, amino, isocyanate groups or derivatives thereof such as esters, epoxides, amides, blocked isocyanates.

9. A polymer/copolymer as claimed in claim 7 wherein the regulators are selected from polyols, hydroxyacids, polyacids, polycarboxylic acid anhydrides, polyamines, amino acids, polyisocianates, and polyepoxides.

10. A polymer/copolymer as claimed in claim 7 wherein one of the regulators is a diol, polyethylene glycol, perfluoropolyether with terminal hydroxy, acid, ester, amido groups or a polyol and the other is a diacid or a polyacid or corresponding anhydrides.

11. A polymer as claimed in claim 10 wherein one of the chain regulators is ethylene glycol, 1,3 or 1,2 propylene glycol, 1,4-butanediol, 1,6-hexanediol, 1,8-octanediol, a diol derived from oligomerisation/copolymerization of ethylene oxide, propylene oxide and THF, trimethylolpropane, pentaerythritol, dipentaerythritol, cyclodextrin and polyols derived from sugars, 1,4-, 1,2- or 1,3-benzenedimethanol, 1,4-, 1,2- or 1,3-cyclohexanedimethanol, polyethylene glycol, perfluoropolyether with terminal hydroxy, acid, ester, amido groups, and the other is mellitic anhydride, fumaric anhydride, succinic anhydride or phthalic anhydride, maleic anhydride, 1,2,4,5-benzenetetracarboxylic acid dianhydride (pyromellitic anhydride).

12. A polymer as claimed in claim 6 wherein the silica or montmorillonite is functionalized with one or more silanes of formula 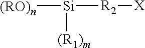
in which R and R1═—CH₃, —CH₂CH₃ or i-propyl, n═1-3, m═3-n, R2═—CH₂—, —(CH₂)₂—, —(CH₂)₃— and X=epoxide, —NH₂, aliphatic chain C5-C15, —NCO, —NH—(CH₂)x-NH₂, aryl groups optionally in mixture with silanes of formula (CH3)ₓ—Si—(OR)₄₋ₓ, wherein x is 4 or lower, in amounts of up to 50% in moles of the functionalized silane.

13. A polymer as claimed in claim 12 wherein the amount of silane present on the silica or montmorillonite can range between 0.01% and 80% by weight of the mineral.
